(19) United States
(12) Patent Application Publication
(10) Pub. No.: US 2026/0369255 A1
(43) Pub. Date: Nov. 19, 2026

(54) Soft Fabric Guitar Headstock Protector with Optional Accessory Pocket

(71) Applicant: Drew Kalies, Ventura, CA (US)

(72) Inventor: Drew Kalies, Ventura, CA (US)

(21) Appl. No.: 19/212,631

(22) Filed: May 19, 2025

(51) Int. Cl. G10G 7/00

(52) U.S. Cl. CPC G10G 7/00

(57) ABSTRACT

A protective fabric sleeve designed to cover and protect the headstock of a guitar. The sleeve features a closed top and open bottom, optionally equipped with a cinching mechanism for securing the sleeve in place. An optional external pocket is provided to hold accessories such as guitar picks. When applied, the sleeve allows the guitar to be leaned against a wall without damaging either the wall or the guitar due to the soft covering over sharp tuning knobs. The sleeve's limited coverage area allows the guitar neck, strings, and body to remain visible, preserving the instrument's visual appeal while offering practical protection.

### FIELD OF THE INVENTION

The present invention relates generally to protective accessories for musical instruments and, more particularly, to a soft, fabric-based protector designed specifically for the headstock of a guitar, optionally including a pocket for small accessories such as guitar picks.

### BACKGROUND OF THE INVENTION

The headstock of a guitar is susceptible to cosmetic damage such as scratches, scuffs, and dings during routine handling, storage, or display. While hard and soft guitar cases provide generalized protection, they often lack focused coverage for the headstock, particularly when the instrument is not in a case or is stored on a stand.

Many existing solutions are bulky, overcomplicated, or cover unnecessary areas of the guitar. There exists a need for a lightweight, fabric-based solution that protects only the headstock and offers additional utility, such as optional storage for guitar picks or other small items.

### SUMMARY OF THE INVENTION

The invention is a protective sleeve designed to slide over the headstock of a guitar. The sleeve is fabricated from soft, durable material and shaped generally as a square or rectangle when laid flat. The top is closed, while the bottom is open and may optionally include a cinching feature such as a drawstring, elastic hem, or hook-and-loop fastener.

An optional pocket may be included on the exterior of the sleeve to hold small accessories such as guitar picks, string winders, or other items. This pocket may be integrated into the sleeve during manufacturing and may include its own closure system (e.g., flap, snap, zipper, or hook-and-loop).

Once the sleeve is applied to the guitar headstock, the guitar may be leaned against a wall or other vertical surface for temporary storage without risking damage to the wall or the guitar. This is particularly beneficial in protecting surfaces from the protruding sharp edges of tuning knobs, which can otherwise scratch or dent nearby objects.

This invention provides gentle protection from physical wear and environmental elements, and improves user convenience with optional storage, all while remaining compact and easy to use. Importantly, the device protects only the headstock, allowing the user to continue enjoying the visual appeal of the guitar's neck, strings, and body while it remains on display or in use.

### BRIEF DESCRIPTION OF THE DRAWINGS

FIG. 1 is a perspective view of the headstock protector in use on a guitar headstock.

FIG. 2 is a front view of the protector laid flat, showing its general shape and the optional pocket.

FIG. 3 is a side cross-sectional view illustrating the fabric construction.

FIG. 4 is a detail view of the optional cinching mechanism at the open end.

FIG. 5 is a close-up view of the optional accessory pocket and its closure.

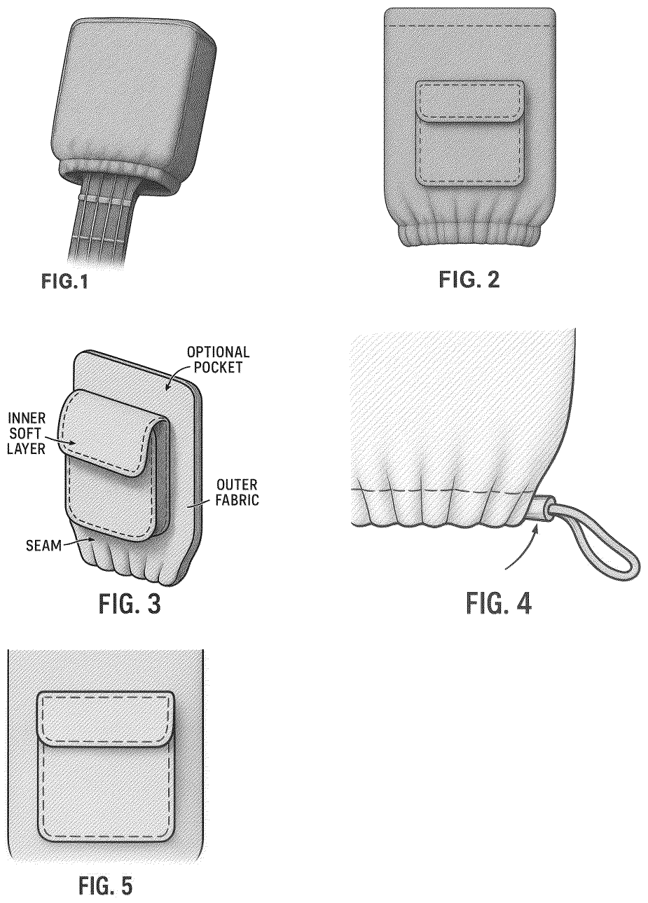

### DETAILED DESCRIPTION OF THE INVENTION

The guitar headstock protector comprises a sleeve made from soft, flexible fabric, such as fleece, cotton, polyester, or microfiber. The sleeve has a closed top end and an open bottom end through which the guitar headstock can be inserted.

The open bottom end may optionally include a cinching mechanism such as a drawstring with toggle, an elastic hem, or a hook-and-loop fastener. This allows the protector to be secured snugly around various headstock shapes and sizes.

The sleeve is generally rectangular or square when laid flat, with approximate dimensions of about 7 inches wide by 9 inches long, though this may vary depending on specific instrument models.

The inner surface of the sleeve is made of a soft material to minimize finish wear. The fabric may be single- or multi-layer.

An optional pocket may be located on the exterior surface of the sleeve. It can store accessories such as picks or tools, and may include a closure system like a zipper, snap, or hook-and-loop fastening to secure its contents.

When the sleeve is in place on the guitar headstock, it allows the instrument to be leaned against a wall or vertical surface without causing damage. The fabric covering buffers the typically sharp tuning knobs, protecting both the instrument and any surfaces it may contact.

In addition, because the protector is limited to the headstock, the neck, strings, and body of the guitar remain fully visible and accessible. This ensures that the aesthetic and tactile experience of the instrument is preserved, whether on display or in use.

1. A guitar headstock protector, comprising: a sleeve constructed of soft, flexible fabric; said sleeve having a closed top end and an open bottom end; said open bottom end adapted to receive the headstock of a guitar.

2. The guitar headstock protector of claim 1, wherein the sleeve is generally rectangular or square in shape when laid flat.

3. The guitar headstock protector of claim 1, further comprising an inner surface made from a material softer than the outer surface.

4. The guitar headstock protector of claim 1, optionally comprising a cinching mechanism at the open bottom end.

5. The guitar headstock protector of claim 4, wherein the optional cinching mechanism is selected from the group consisting of a drawstring, an elastic hem, and a hook-and-loop fastener.

6. The guitar headstock protector of claim 1, optionally comprising an accessory pocket attached to an outer surface of said sleeve.

7. The guitar headstock protector of claim 6, wherein said optional pocket includes a closure mechanism selected from the group consisting of a zipper, snap, flap, and hook-and-loop fastener.

8. The guitar headstock protector of claim 1, wherein said sleeve is made from fabric selected from the group consisting of fleece, cotton, polyester, and microfiber.

9. The guitar headstock protector of claim 1, wherein the sleeve is sized to accommodate a variety of standard guitar headstock shapes.

10. The guitar headstock protector of claim 1, wherein said sleeve is lightweight and compressible for convenient storage.

11. The guitar headstock protector of claim 1, wherein the sleeve enables the guitar to be leaned against a wall without damaging the wall or the guitar, by covering tuning knobs and other protrusions.

12. The guitar headstock protector of claim 1, wherein the neck, strings, and body of the guitar remain exposed while the headstock is protected, allowing continued aesthetic appreciation and ease of use.
